(19) United States
(12) Patent Application Publication
(10) Pub. No.: US 2022/0267510 A1
(43) Pub. Date: Aug. 25, 2022

(54) POLYURETHANE FOAM WITH IMPROVED COMBUSTION BEHAVIOR

(71) Applicant: Dow Global Technologies LLC, Midland, MI (US)

(72) Inventors: Dakai Ren, Manvel, TX (US); Luigi Bertucelli, Corregio (IT); Weijun Zhou, Lake Jackson, TX (US); Eddy I. Garcia-Meitin, Angleton, TX (US); Yiqun Zhang, Katy, TX (US); William J. Harris, Lake Jackson, TX (US)

(73) Assignee: Dow Global Technologies LLC, Midland, MI (US)

(21) Appl. No.: 17/625,608

(22) PCT Filed: Jul. 9, 2020
(86) PCT No.: PCT/US2020/041400

§ 371 Date: Jan. 7, 2022

(30) Foreign Application Priority Data
Jul. 12, 2019 (IT) 102019000011577

(51) Int. Cl. C08G 18/76; C08J 9/14; C08J 9/00; C08G 18/18; C08G 18/22; C08G 18/42; C08G 18/09

(52) U.S. Cl. CPC C08G 18/7664; C08J 9/141; C08J 9/0052; C08J 9/0038; C08G 18/1808; C08J 2203/14; C08G 18/4213; C08G 18/092; C08G 2110/005; C08G 2110/0025; C08J 2375/08; C08G 18/225

(57) ABSTRACT

The present disclosure provides for an isocyanate-reactive composition that can react with an isocyanate compound in a reaction mixture to form a polyurethane-based foam. The isocyanate-reactive composition includes an isocyanate reactive compound and a combustion modifier composition. The isocyanate reactive compound has an isocyanate reactive moiety and an aromatic moiety. The combustion modifier composition includes both phosphorus from a halogen-free flame-retardant compound and a transition metal from a transition metal compound. The combustion modifier composition can have a molar ratio of the transition metal to phosphorus (mole transition metal:mole phosphorous) of 0.05:1 to 5:1.

C

### FIELD OF DISCLOSURE

The present disclosure relates generally to polyurethane-based foams and more particularly to polyurethane-based foams with improved combustion behavior.

### BACKGROUND

Polyurethane rigid (PUR) foam has been used in construction since the 1960s as a high-performance insulation material. Continued technical developments in Europe and the US have led to the next product generation called polyisocyanurate rigid (PIR) foam. Both PUR and PIR are polyurethane-based foams manufactured from the two reactants, isocyanate (e.g., methyl diphenyl diisocyanate, MDI) and polyol. While for PUR, the isocyanate and polyol are implemented near a balanced ratio compared to the equivalent weights, the isocyanate is used in excess during the production of PIR. The isocyanate reacts in part with itself, where the resulting PIR is a heavily cross-linked synthetic material with ring-like isocyanurate structures. The high degree of linkage and the ring structures ensure the high thermal stability of the rigid PIR foam. PIR also has superior dimensional stability.

PIR foams are also characterized by a very good reaction to fire behavior thanks to the inherent charring behavior, in turn related to the outstanding thermal stability of the isocyanurate chemical structure. To further enhance char formation, it is common to add a phosphorous-based flame retardant. When a building product, such as an insulating metal panel or an insulation board, is exposed to fire, the insulating PIR core rapidly forms a coherent char that helps protecting underlying material. That translates to only a limited portion of the available combustible insulating material exposed to the fire that actually contributes in terms of heat release and smoke.

Fire behavior of combustible thermoset material is a complex matter. As an example, halogenated flame retardants are very effective in reducing heat release but may worsen smoke opacity. Dow patent publication US 2014/0206786 A1 describes use of triethyl phosphate (TEP) as a smoke suppressant additive when compared with conventional halogenated flame retardant such as tris-(2-chloroisopropyl)phosphate (TCPP). Moreover, as is well known, the composition of combustion effluents (further than on the material itself) strongly depends on fire conditions, particularly temperature, geometry and ventilation including availability of oxygen.

Even if, as noted above, the intrinsic charring behavior of polyisocyanurate limits and/or delays the amount of polymer burned (therefore limiting and/or delaying the release of heat and smoke), still it is desirable to further modify the combustion/burning behavior and therefore reduce as much as possible smoke opacity and smoke toxicants.

### SUMMARY

The present disclosure provides for a polyurethane-based foam having improved combustion behavior with respect to emission of hydrogen cyanide (HCN) and carbon monoxide (CO) during a pyrolysis event (e.g., a fire). The polyurethane-based foam is formed with a reaction mixture that includes both an isocyanate compound and an isocyanate-reactive composition. The isocyanate-reactive composition for the polyurethane-based foam includes, besides other things, phosphorus from a halogen-free flame-retardant compound and a transition metal from a transition metal compound that together help to produce a significant reduction in both HCN and CO production during pyrolysis of the polyurethane-based foam.

For the embodiments of the present disclosure, the isocyanate-reactive composition for forming the polyurethane-based foam includes an isocyanate reactive compound and a combustion modifier composition. The isocyanate reactive compound has an isocyanate reactive moiety and an aromatic moiety, where the aromatic moiety is 5 weight percent (wt. %) to 80 wt. % of the isocyanate reactive compound based on the total weight of the isocyanate reactive compound. The combustion modifier composition includes both 0.1 wt. % to 7.0 wt. % of phosphorus from the halogen-free flame-retardant compound and 0.05 wt. % to 14.0 wt. % of the transition metal from the transition metal compound, where the wt. % of the transition metal and the wt. % of the phosphorus are each based on the total weight of the isocyanate reactive compound, the halogen-free flame-retardant compound and the transition metal compound). For these given wt. % values, the combustion modifier composition can have a molar ratio of the transition metal to phosphorus (mole transition metal:mole phosphorous) of 0.05:1 to 5:1.

For the embodiments provided herein, the halogen-free flame-retardant compound can be selected from the group consisting of a phosphate, a phosphonate, a phosphinate and combinations thereof. For the embodiments provided herein, the transition metal compound can be selected from the group consisting of an oxide, a carboxylate, a salt, a coordination compound and combinations thereof, where the transition metal can be selected from the group consisting of copper, iron, manganese, cobalt, nickel, zinc, and combinations thereof. Preferably, the transition metal compound is selected from the group consisting of copper (I) oxide, copper (II) oxide, ethylenediaminetetraacetic acid (EDTA) copper disodium salt and combinations thereof. For the various embodiments, the transition metal compound preferably has a median particle diameter (D50) of 10 nm to 10 μm. For the embodiments provided herein, the isocyanate reactive moiety of the isocyanate reactive compound can be a hydroxyl moiety, where the isocyanate reactive compound is selected from the group consisting of a polyether polyol, a polyester polyol, polycarbonate polyol, a polyestercarbonate polyol, a polyethercarbonate polyol and combinations thereof. For the various embodiments, the isocyanate-reactive composition provided herein can also include a catalyst, a surfactant, a blowing agent or combinations thereof.

The reaction mixture for forming the polyurethane-based foam includes both the isocyanate compound having the isocyanate moiety and the isocyanate reactive compound having the isocyanate reactive moiety and the aromatic moiety comprising 5 wt. % to 80 wt. % of the isocyanate reactive compound based on the total weight of the isocyanate reactive compound, as provided herein. For the embodiments herein, the reaction mixture can have a molar ratio of the isocyanate moiety to the isocyanate reactive moiety of 1.2:1 to 7:1. For example, the isocyanate reactive moiety of the isocyanate-reactive composition is a hydroxyl moiety, where the reaction mixture has a molar ratio of the isocyanate moiety to the hydroxyl moiety of 1.2:1 to 7:1. The reaction mixture also includes 0.1 wt. % to 7.0 wt. % of phosphorus from the halogen-free flame-retardant compound and 0.05 wt. % to 14.0 wt. % of a transition metal from the transition metal compound, where the wt. % values of phosphorus and the transition metal are based on a total weight of the isocyanate reactive compound, the halogen-free flame-retardant compound and the transition metal compound. The reaction mixture can further optionally include a catalyst, a surfactant and a blowing agent for forming the polyurethane-based foam. As discussed herein, the polyurethane-based foam is formed with the reaction mixture.

The present disclosure also provides for a process for preparing a reaction mixture for producing a polyurethane-based foam. The process can include providing an isocyanate compound having an isocyanate moiety; providing an isocyanate reactive compound having an isocyanate reactive moiety and an aromatic moiety comprising 5 wt. % to 80 wt. % of the isocyanate reactive compound based on the total weight of the isocyanate reactive compound; providing 0.1 wt. % to 7.0 wt. % of phosphorus from a halogen-free flame-retardant compound and 0.05 wt. % to 14.0 wt. % of a transition metal from a transition metal compound, wherein the wt. % values of phosphorus and the transition metal are based on a total weight of the isocyanate reactive compound, the halogen-free flame-retardant compound and the transition metal compound; optionally providing a catalyst, a surfactant and a blowing agent; and admixing the isocyanate compound, the isocyanate reactive compound, the halogen-free flame-retardant compound; the transition metal compound; the optional catalyst, surfactant and blowing agent to form the reaction mixture. For the various embodiments, the reaction mixture can have a molar ratio of the isocyanate moiety to the isocyanate reactive moiety of 1.2:1 to 7:1. Admixing to form the reaction mixture can also include providing a molar ratio of the transition metal to phosphorus (moles transition metal:moles phosphorous) of 0.05:1 to 5:1 in the reaction mixture. An additional embodiment of the process further includes admixing the transition metal compound with a liquid carrier in providing the transition metal from the transition metal compound.

### DETAILED DESCRIPTION

The present disclosure provides for a polyurethane-based foam having improved combustion behavior with respect to emission of hydrogen cyanide (HCN) and carbon monoxide (CO) during a pyrolysis event (e.g., a fire). The polyurethane-based foam is formed with a reaction mixture that includes both an isocyanate compound and an isocyanate-reactive composition. For the embodiments of the present disclosure, the isocyanate-reactive composition for forming the polyurethane-based foam comprises an isocyanate reactive compound having an isocyanate reactive moiety and an aromatic moiety as provided herein. The isocyanate-reactive composition also comprises phosphorus from a halogen-free flame-retardant compound and a transition metal from a transition metal compound that together help to produce a significant reduction in both HCN and CO production during pyrolysis of the polyurethane-based foam.

For the various embodiments, the isocyanate reactive moiety of the isocyanate reactive compound is a hydroxyl moiety, where the isocyanate reactive compound can be selected from the group consisting of a polyether polyol, a polyester polyol, a polycarbonate polyol, a polyestercarbonate, a polyethercarbonate polyol and combinations thereof. For the various embodiments, the isocyanate reactive compound can include two or more of the hydroxyl moiety, where the active hydrogen atoms are reactive with the carbon atom of the isocyanate group (—N═C═O) of the isocyanate compound. The isocyanate reactive compound can have a number average molecular weight of 100 g/mol to 2,000 g/mol. Other number average molecular weight values may also be possible. For example, the isocyanate reactive compound can have a number average molecular weight from a low value of 100, 200, 300, 350 or 400 g/mol to an upper value of 500, 750, 1,000, 1,500 or 2,000 g/mol. The number average molecular weight values reported herein are determined by end group analysis, gel permeation chromatography, and other methods as is known in the art.

The isocyanate reactive compound also includes an aromatic moiety. For the various embodiments, the aromatic moiety is 5 weight percent (wt. %) to 80 wt. % of the isocyanate reactive compound based on the total weight of the isocyanate reactive compound. Preferably, the aromatic moiety constitutes 8 wt. % to 50 wt. % of the isocyanate reactive compound based on the total weight of the isocyanate reactive compound. More preferably, the aromatic moiety constitutes 10 wt. % to 40wt. % of the isocyanate reactive compound based on the total weight of the isocyanate reactive compound. As used herein, an “aromatic moiety” is at least one cyclically conjugated molecular moiety in the form of a planar unsaturated ring of carbon atoms that is covalently attached to the isocyanate reactive compound. The planar unsaturated ring of carbon atoms can have at least six (6) carbon atoms. To illustrate, the isocyanate reactive compound bis(2-hydroxyethyl) terephthalate with a molecular formula of C₁₂—H₁₄O₆ and formula weight of 254.2 gram/mole and would have an aromatic content corresponding to a molecular formula of C₆H₄ with corresponding formula weight of 76.1 gram/mole with the aromatic moiety of bis(2-hydroxyethyl) terephthalate being 29.9 weight percent (wt. %).

For some embodiments, the polyether polyol can include those having at least 2, such as 2 or 3 hydroxyl groups per molecule and may be prepared, for example, by polymerization of oxirane/cyclic ethers, such as ethylene oxide, propylene oxide, butylene oxide, styrene oxide or epichlorohydrin, either on their own, in the presence of BF₃, or by a process of chemical addition of these oxiranes, optionally as mixtures (such as mixtures of ethylene oxide and propylene oxide) or successively, to starting components having reactive hydrogen atoms, such as water, ammonia, alcohols, or amines. Examples of suitable starting components include ethylene glycol, propylene glycol-(1,3) or -(1,2), glycerol, trimethylolpropane, 4,4′-dihydroxy-diphenylpropane, Novolac, aniline, ethanolamine, o-toluenediamine or ethylene diamine. Sucrose-based polyether polyols may also be used. It is in many cases preferred to use polyethers which contain predominant amounts of primary OH groups (up to 100% of the OH groups present in the polyether).

For some embodiments, the polyester polyol can include those having at least 1.8 to 3 hydroxyl groups per molecule (average number). Examples of such polyester polyols can include those formed as a reaction product of polyhydric, such as dihydric alcohols and/or trihydric alcohols, and polybasic, such as dibasic and/or tribasic, carboxylic acids. Instead of free polycarboxylic acids, the corresponding polycarboxylic acid anhydrides or corresponding polycarboxylic acid esters of lower alcohols or mixtures thereof may be used as well as their mixtures with free polycarboxylic acids. The polycarboxylic acids may be aliphatic, cycloaliphatic, aromatic and/or heterocyclic and they may be substituted, e.g. by halogen atoms, and/or may be unsaturated. Suitable exemplary polycarboxylic acids, anhydrides, and polycarboxylic acid esters of lower alcohols include, but are not limited to, succinic acid, adipic acid, suberic acid, azelaic acid, sebacic acid, phthalic acid, isophthalic acid, terephthalic acid, trimellitic acid, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids optionally mixed with monomeric fatty acids, dimethyl terephthalate and terephthalic acid-bis-glycol esters. Examples of other suitable polyester polyols include modified aromatic polyester polyols such as those provided under the trade designator STEPANPOL PS-2352 (acid number, max 0.6-1.0 mg KOH/g, hydroxyl number 230-250 mg KOH/g, functionality 2.0, Stepan Company).

Exemplary suitable polyhydric alcohols include, but are not limited to, ethylene glycol, propylene glycol-(1,2) and -(1,3), butylene glycol-(1,4) and -(2,3), hexanediol-(1,6), octanediol-(1,8), neopentylglycol, cyclohexanedimethanol (1,4-bis-hydroxy-methylcyclohexane and other isomers), 2-methyl-1,3-propane-diol, glycerol, trimethylolpropane, hexanetriol-(1,2,6), butanetriol-(1,2,4), trimethylolethane, pentaerythritol, quinitol, mannitol and sorbitol, methyl glycoside, diethylene glycol, triethylene glycol, tetraethylene glycol, polyethylene glycols, dipropylene glycol, polypropylene glycols, dibutylene glycol and polybutylene glycols. The polyesters may also contain a proportion of carboxyl end groups. Polyesters of lactones, such as ε-caprolactone, or hydroxycarboxylic acids, such as co-hydroxycaproic acid, may also be used.

For some embodiments, the polyester polyols are aromatic polyester polyols. Examples of the aromatic polyester polyols include those formed from the reaction products of aromatic polybasic acids and aliphatic polyhydric alcohols. Other examples include the reaction products formed from the reaction of polybasic acids comprising at least one of terephthalic acid, isophthalic acid, phthalic acid, phthalic anhydride, trimellitic acid, or trimellitic anhydride and aliphatic polyhydric alcohols comprising at least one of ethylene glycol, propylene glycol, diethylene glycol, polyethylene glycol, polypropylene glycol, or glycerol. In additional examples, the aromatic polyester polyols are reaction products formed from polybasic acid of terephthalic acid and from aliphatic polyhydric alcohols comprising diethylene glycol, polyethylene glycol, and/or glycerol. For the various embodiments, the aromatic polyester polyol has an aromatic content from a low value of 8, 10, 12, or 14 weight % (wt. %) and a high value of 18, 20, 30, or 40 wt. % based on the total weight of the polyester polyol, where any combination of the low value and the high value as provided is possible (e.g., the aromatic content of the aromatic polyester polyol is from 8 wt. % to 40 wt. %). For some embodiments, the aromatic polyester polyol has an average hydroxyl functionality as low as 1.8, 1.9, or 2.0 and as high as 2.4. 2.7, or 3.0, where any combination of the low value and the high value as provided is possible (e.g., the average hydroxyl functionality is from 1.8 to 3.0). For some embodiments, the aromatic polyester polyol has a number average molecular weight as low as 300, 350, 400, or 425 and as high as 525, 550, 600, or 800, where any combination of the low value and the high value as provided is possible (e.g., the number average molecular weight of the aromatic polyester polyol is from 300 to 800).

Such polyol components may also include polycarbonate polyols, such as the reaction product of diols, such as propanediol-(1,3), butanediol-(1,4) and/or hexanediol-(1,6), diethylene glycol, triethylene glycol or tetraethylene glycol, with diarylcarbonates, such as diphenylcarbonate, dialiphaticcarbonates, such as dimethylcarbonate or phosgene or from the reaction of oxiranes and carbon dioxide

Other examples of suitable isocyanate reactive compounds include those polymers or copolymers formed with propylene oxide that have a hydroxyl equivalent weight of at least 75. The propylene oxide may be 1,3-propylene oxide, but more typically is 1,2-propylene oxide. If a copolymer, the comonomer is another copolymerizable alkylene oxide such as, for example, ethylene oxide, 2,3-butylene oxide, tetrahydrofuran, 1,2-hexane oxide, and the like. A copolymer may contain 25% or more by weight, 50% or more by weight and preferably 75% or more by weight polymerized propylene oxide. The isocyanate reactive compounds can also include those polymers formed with 100% propylene oxide based on the total weight of polymerized alkylene oxides. A copolymer preferably contains no more than 75%, especially no more than 50% by weight polymerized ethylene oxide. The polymer or copolymer of propylene oxide should have a nominal functionality of at least 2.0. The nominal functionality preferably is 2.5 to 8, more preferably 2.5 to 7 or 2.5 to 6. The hydroxyl equivalent weight of the polymer or copolymer of propylene oxide is at least 100, preferably at least 150, more preferably 150 to 1,000, in some embodiments 150 to 750. The isocyanate reactive compound can also be formed of a blend, where the polyol blend can include a blend of the diol and triol. The diol can have an average molecular weight (Mw) of 300 to 8,000 grams/mole and a triol having an average molecular weight (Mw) of 500 to 6,500 grams/mole.

In various embodiments, suitable isocyanate reactive compounds without an aromatic moiety can be formed as a blend with suitable isocyanate reactive compounds with an aromatic moiety. In isocyanate reactive compounds which are blends of non-aromatic isocyanate reactive compounds and aromatic containing isocyanate reactive compounds, the isocyanate reactive compound containing the aromatic moiety has the aromatic content of 5 weight percent (wt. %) to 80 wt. %. Preferably, the aromatic moiety constitutes 8 wt. % to 50 wt. % of the isocyanate reactive compound containing the aromatic moiety. More preferably, the aromatic moiety constitutes 10 wt. % to 40 wt. % of the isocyanate reactive compound containing the aromatic moiety.

In various embodiments, the isocyanate reactive compound can have a hydroxyl number of from 10 mg KOH/g to 700 mg KOH/g. In still other embodiments, the isocyanate reactive compound has a hydroxyl number of from 100 mg KOH/g to 500 mg KOH/g, or from 150 mg KOH/g to 400 mg KOH/g or from 190 mg KOH/g to 350 mg KOH/g. As used herein, a hydroxyl number is the milligrams of potassium hydroxide equivalent to the hydroxyl content in one gram of the polyol or other hydroxyl compound. The polyol can also have a number averaged isocyanate reactive group functionality of 1.8 to 3, such as 2 to 2.7 or 2 to 2.5.

For the various embodiments, the polyether polyol and/or a polyester polyol can also be uncapped or capped using ethylene oxide (EO) and/or propylene oxide (PO), as known in the art, to provide hydrophilic or hydrophobic structures.

In the present disclosure, other isocyanate-reactive compositions besides the polyol component can be used in forming the isocyanate-reactive composition of the present disclosure. This allows for a two-component system for the isocyanate-reactive composition, where the amine can be used as the curative agent in place or in addition to the polyol as provided herein. Such isocyanate-reactive compositions can include an aromatic diamine, such as those which contain at least one alkyl substituent in the ortho-position to a first amino group and two alkyl substituents in the ortho-position to a second amino group or mixtures thereof. In some embodiments, at least two of the alkyl substituents contain at least two carbon atoms. In certain embodiments, the reactivity of the diamine towards isocyanates has not been reduced by electron attracting substituents, such as halogen, ester, ether or disulphide groups, as is the case, for example, with methylene-bis-chloroaniline (MOCA). In certain embodiments, such diamines do not contain other functional groups reactive with isocyanates. In certain embodiments, the foregoing mentioned alkyl substituent can have as many as twenty carbon atoms and can be straight or branched long chains.

The isocyanate-reactive composition for forming the polyurethane-based foam also includes a combustion modifier composition. For the various embodiments, the combustion modifier composition includes 0.1 wt. % to 7.0 wt. % of phosphorus from a halogen-free flame-retardant compound and 0.05 wt. % to 14.0 wt. % of a transition metal from a transition metal compound, where the wt. % of phosphorus and the transition metal are based on a total weight of the isocyanate reactive compound, the halogen-free flame-retardant compound and the transition metal compound. Preferably, the combustion modifier composition includes 0.3 wt. % to 5.0 wt. % of phosphorus from a halogen-free flame-retardant compound, the wt. % of phosphorus from the halogen-free flame-retardant compound based on a total weight of the isocyanate reactive compound, the halogen-free flame-retardant compound and the transition metal compound, and 0.1 wt. % to 5.0 wt. % of the transition metal from the transition metal compound based on a total weight of the isocyanate reactive compound, the halogen-free flame-retardant compound and the transition metal compound. More preferably, the combustion modifier composition includes 1.0 wt. % to 3.0 wt. % of phosphorus from a halogen-free flame-retardant compound, the wt. % of phosphorus from the halogen-free flame-retardant compound based on a total weight of the isocyanate reactive compound, the halogen-free flame-retardant compound and the transition metal compound, and 0.3 wt. % to 2.0 wt. % of the transition metal from the transition metal compound based on a total weight of the isocyanate reactive compound, the halogen-free flame-retardant compound and the transition metal compound. For the given weight percent values, the combustion modifier composition has a molar ratio of the transition metal to phosphorus (mole transition metal : mole phosphorous) of 0.05:1 to 5:1. Preferably, the molar ratio of the transition metal to phosphorus (mole transition metal : mole phosphorous) is 0.10:1 to 3:1. More preferably, the molar ratio of the transition metal to phosphorus (mole transition metal : mole phosphorous) is 0.15:1 to 1:1.

For the embodiments provided herein, the halogen-free flame-retardant compound is selected from the group consisting of a phosphate, a polyphosphate, a phosphonate, a phosphinate, a biphosphinate, and combinations thereof. Examples of the phosphate include trialkyl phosphate, triaryl phosphate, a phosphate ester and resorcinol bis(diphenyl phosphate). As used herein, a trialkyl phosphate has at least one alkyl group with 2 to 12 carbon atoms. The other two alkyl groups of the trialkyl phosphate may, independently be the same or different than the first alkyl group, containing from one to 8 carbon atoms, including a linear or branched alkyl group, a cyclic alkyl group, an alkoxyethyl, a hydroxylalkyl, a hydroxyl alkoxyalkyl group, and a linear or branched alkylene group. Examples of the other two alkyl groups of the trialkyl phosphate include, for example, methyl, ethyl, propyl, butyl, n-propyl, isopropyl. n-butyl, isobutyl, sec-butyl, tert-butyl, butoxyethyl, isopentyl, neopentyl, isohexyl, isoheptyl, cyclohexyl, propylene, 2-methylpropylene, neopentylene, hydroxymethyl, hydroxyethyl, hydroxypropyl or hydroxybutyl. Blends of different trialkyl phosphates may also be used. The three alkyl groups of the trialkyl phosphate may be the same. The trialkyl phosphate is desirably triethyl phosphate (TEP).

Examples of the phosphonate include diethyl (hydroxymethyl)phosphonate, dimethyl methyl phosphonate and diethyl ethyl phosphonate. Examples of the phosphinate include a metal salt of organic phosphinate such as aluminum methylethylphosphinate, aluminum diethylphosphinate, zinc methylethylphosphinate, and zinc diethylphosphinate. Examples of additional halogen-free flame-retardant compounds include 9,10-dihydro-9-oxa-10-phosphaphenanthrene-10-oxide, ammonium polyphosphate and combinations thereof.

For the embodiments provided herein, the transition metal compound is selected from the group consisting of an oxide, a carboxylate, a salt, a coordination compound, and combinations thereof and the transition metal is selected from the group consisting of copper, iron, manganese, cobalt, nickel, zinc and combinations thereof. Examples of the transition metal compound include copper (I) oxide, copper (II) oxide, copper (II) acetate, copper (I) acetate, copper butyrate, ethylenediaminetetraacetic acid (EDTA) copper disodium salt, di-μ-hydroxo-bis[(N,N,N′,N′-tetramethylethylenediamine)copper(II)] chloride, zinc stannate, zinc hydroxystannate, manganese (II) 2-ethylhexanoate, dicyclopentadienyl iron (Ferrocene) and combinations thereof. Preferably, the transition metal compound is selected from the group consisting of copper (I) oxide, copper (II) oxide, ethylenediaminetetraacetic acid (EDTA) copper disodium salt and combinations thereof. The transition metal compounds of the present disclosure have little or no impact on the reaction of the isocyanate and the isocyanate reactive composition. The transition metal compound preferably does not reduce the isocyanurate concentration by 40% or more in the polyurethane foam as compared to the same polyurethane foam formulation without the transition metal compound. More preferably, the transition metal compound does not reduce the isocyanurate concentration by 30% or more in the polyurethane foam as compared to the same polyurethane foam formulation without the transition metal compound. Most preferably, the transition metal compound does not reduce the isocyanurate concentration by 20% or more in the polyurethane foam as compared to the same polyurethane foam formulation without the transition metal compound.

As discussed in the Examples section below, there is a surprising reduction of HCN generation from pyrolysis of the polyurethane-based foam having the transition metal compound in a given size range. Preferably, the transition metal compound used in forming the polyurethane-based foam of the present disclosure has a median particle diameter (D50) of 1 nm to 100 μm. Preferably, the transition metal compound used in forming the polyurethane-based foam of the present disclosure has a median particle diameter (D50) of 10 nm to 10 μm. Other preferred values of the median particle diameter for the transition metal compound used in forming the polyurethane-based foam of the present disclosure include 5 nm to 50 μm and 10 nm to 20 μm.

For the various embodiments, the isocyanate-reactive composition has a molar ratio of moles of the isocyanate reactive moiety to moles of phosphorous from the halogen-free flame-retardant compound of 70:1 to 1:1. Preferably, the molar ratio of moles of the isocyanate reactive moiety to moles of phosphorous from the halogen-free flame-retardant compound is 35:1 to 2:1. Most preferably, the molar ratio of moles of the isocyanate reactive moiety to moles of phosphorous from the halogen-free flame-retardant compound is 10:1 to 3:1.

For the embodiments provided herein, the isocyanate-reactive composition can further include a catalyst, a surfactant, a blowing agent or combinations thereof. The use of other components known in the art can also be included with the isocyanate-reactive composition for promoting and/or facilitating the use of the isocyanate-reactive composition with the isocyanate compound in the reaction mixture, as provided herein, for forming a polyurethane-based foam.

Water can be included in the reaction mixture, as needed, to advance the reaction and used as a chemical blowing agent. The amount of water present in the reaction mixture can range from 0 to 5 wt. % based on the total weight of the isocyanate reactive composition.

The catalyst can be present in the isocyanate-reactive composition in amount sufficient to provide the reaction mixture with 0.1 to 3.0 wt. % of the catalysts based on the total weight of the reaction mixture. The catalyst can be selected from the group consisting of an organic tertiary amine, tertiary phosphines, potassium acetates, a urethane-based catalyst and combinations. The catalyst can also include organo-tin compounds, as are known in the art.

For the various embodiments, the catalyst may be a blowing catalyst, a gelling catalyst, a trimerization catalyst, or combinations thereof. As used herein, blowing catalysts and gelling catalysts, may be differentiated by a tendency to favor either the urea (blow) reaction, in the case of the blowing catalyst, or the urethane (gel) reaction, in the case of the gelling catalyst. A trimerization catalyst may be utilized to promote the isocyanurate reaction in the compositions.

Examples of blowing catalysts, e.g., catalysts that may tend to favor the blowing reaction include, but are not limited to, short chain tertiary amines or tertiary amines containing an oxygen. The amine-based catalyst may not be sterically hindered. For instance, blowing catalysts include bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT™ 5, from Evonik, among other commercially available blowing catalysts.

Examples of gelling catalysts, e.g., catalyst that may tend to favor the gel reaction, include, but are not limited to, organometallic compounds, cyclic tertiary amines and/or long chain amines, e.g., that contain several nitrogen atoms and combinations thereof. Organometallic compounds include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, triethylenediamine, and combinations thereof, and combinations thereof. Examples of a commercially available gelling catalysts are POLYCAT™ 8 and DABCO™ T-12 from Evonik, among other commercially available gelling catalysts.

Examples of trimerization catalysts include N,N,N′,N″,N″-pentamethyldiethylenetriamine (PMDETA) ; N,N′,N″-Tris(3-dimethylaminopropyl)hexahydro-s-triazine; N,N-dimethylcyclo-hexylamine; 1,3,5-tris(N,N-dimethylaminopropyl)-s-hexahydrotriazine; [2,4,6-Tris(dimethylaminomethyl)phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, combinations thereof, among others. Some commercially available trimerization catalysts include DABCO™ TMR-2, TMR-7, DABCO™ K 2097; DABCO™ K15, POLYCAT™ 41, and POLYCAT™ 46, each from Evonik, among other commercially available trimerization catalysts.

For the various embodiments, the blowing agent can be present in the isocyanate-reactive composition in amount sufficient to provide the reaction mixture with 1.0 to 15 wt. % of the blowing agent based on the total weight of the reaction mixture. The blowing agent, as are known in the art, can be selected from the group consisting of water, volatile organic substances, dissolved inert gases and combinations thereof. Examples of blowing agents include hydrocarbons such as butane, isobutane, 2,3-dimethylbutane, n- and i-pentane isomers, hexane isomers, heptane isomers and cycloalkanes including cyclopentane, cyclohexane, cycloheptane; hydroflurocarbons such as HCFC-142b (1-chloro-1,1-difluoroethane), HCFC-141b (1,1-dichloro-1-fluoroethane), HCFC-22 (chlorodifluoro-methane), HFC-245fa (1,1,1,3,3-pentafluoropropane), HFC-365mfc (1,1,1,3,3-penta-fluorobutane), HFC 227ea (1,1,1,2,3,3,3-heptafluoropropane), HFC-134a (1,1,1,2-tetrafluoroethane), HFC-125 (1,1,1,2,2-pentafluoroethane), HFC-143 (1,1,2-trifluoroethane), HFC 143A (1,1,1-trifluoroethane), HFC-152 (1,1-difluoroethane), HFC-227ea (1,1,1,2,3,3,3-heptafluoropropane), HFC-236ca(1,1,2,2,3,3-hexafluoropropane), HFC 236fa (1,1,1,3,3,3-hexafluoroethane), HFC 245ca (1,1,2,2,3-pentafluoropentane), HFC 356mff (1,1,1,4,4,4-hexafluorobutane), HFC 365mfc (1,1,1,3,3-pentafluorobutane); hydrofluoroolefins such as cis-1,1,1,4,4,4-hexafluoro-2-butene, 1,3,3,3-Tetrafluoropropene, trans-1-chloro-3,3,3-trifluoropropene; a chemical blowing agent such as formic acid and water. The blowing agent can also include other volatile organic substances such as ethyl acetate; methanol; ethanol; halogen substituted alkanes, such as methylene chloride, chloroform, ethylidene chloride, vinylidene chloride, monofluorotrichloromethane, chlorodifluoromethane, dichlorodifluoromethane; butane; hexane; heptane; diethyl ether as well as gases such as nitrogen; air; and carbon dioxide.

For the various embodiments, the surfactant agent can be present in the isocyanate-reactive composition in amount sufficient to provide the reaction mixture with 0.1 to 10 wt. % of the surfactant agent based on the total weight of the reaction mixture. Examples of suitable surfactants include silicone-based surfactants and organic-based surfactants. Some representative materials are, generally, polysiloxane polyoxylalkylene block copolymers, such as those disclosed in U.S. Pat. Nos. 2,834,748; 2,917,480; and 2,846,458, the disclosures of which are incorporated herein by reference in their entireties. Also included are organic surfactants containing polyoxyethylene-polyoxybutylene block copolymers, as are described in U.S. Pat. No. 5,600,019, the disclosure of which is incorporated herein by reference in its entirety. Other surfactants include polyethylene glycol ethers of long-chain alcohols, tertiary amine or alkanolamine salts of long-chain allyl acid sulfate esters, alkylsulfonic esters, alkyl arylsulfonic acids and combinations thereof.

The reaction mixture can further include a filler along with other additives in addition to water, a catalyst, a blowing agent, a surfactant and combinations thereof. The total amount of such other additives present in the isocyanate-reactive composition can be sufficient to provide the reaction mixture with 0.01 to 3.0 wt. % of the other additives (e.g., a filler) based on the total weight of the reaction mixture. The use of other additives for polyurethane foams are also known and may be used with the present disclosure.

The reaction mixture for forming the polyurethane-based foam of the present disclosure includes the isocyanate compound having the isocyanate moiety and the isocyanate reactive compound having the isocyanate reactive moiety and the aromatic moiety comprising 5 wt. % to 80 wt. % of the isocyanate reactive compound based on the total weight of the isocyanate reactive compound, as provided herein. For the embodiments herein, the reaction mixture can have a molar ratio of the isocyanate moiety to the isocyanate reactive moiety of 1.2:1 to 7:1. Preferably, the molar ratio of the isocyanate moiety to the isocyanate reactive moiety is 1.5:1 to 5:1. More preferably, the molar ratio of the isocyanate moiety to the isocyanate reactive moiety is 2:1 to 4:1. Preferably, the isocyanate reactive moiety of the isocyanate-reactive compound is a hydroxyl moiety, where the reaction mixture has a molar ratio of the isocyanate moiety to the hydroxyl moiety of 1.2:1 to 7:1; preferably 1.5:1 to 5:1 and more preferably 2:1 to 4:1.

The reaction mixture also includes 0.1 wt. % to 7.0 wt. % of phosphorus from the halogen-free flame-retardant compound and 0.05 wt. % to 14.0 wt. % of a transition metal from the transition metal compound, where the wt. % values of phosphorus and the transition metal are based on a total weight of the isocyanate reactive compound, the halogen-free flame-retardant compound and the transition metal compound. For the various embodiments, the halogen-free flame-retardant compound and/or the transition metal compound can be included in a mixture with either the isocyanate compound and/or the isocyanate reactive compound, where when both the halogen-free flame-retardant compound and the transition metal compound are included with the isocyanate reactive compound of the present disclosure this mixture can provide for the isocyanate-reactive composition of the present disclosure. The reaction mixture further optionally includes a catalyst, a surfactant and a blowing agent, each as provided herein, for forming the polyurethane-based foam. As discussed herein, the polyurethane-based foam is formed with the reaction mixture.

For the various embodiments, the isocyanate compound has a number average molecular weight of 150 g/mol to 750 g/mol. Other number average molecular weight values may also be possible. For example, the isocyanate reactive compound can have a number average molecular weight from a low value of 150, 200, 250 or 300 g/mol to an upper value of 350, 400, 450, 500 or 750 g/mol. In some embodiments, when the isocyanate compound is an isocyanate prepolymer resulting from reaction of an isocyanate reactive compound with a molar excess of a polyisocyanate compound or polymeric isocyanate compound under conditions that do not lead to gelation or solidification, the isocyanate prepolymers can have a higher a number average molecular weight than 750 g/mol and can be calculated from the number average molecular weight of each component and their relative masses used in preparing the prepolymer. The number average molecular weight values reported herein are determined by end group analysis, gel permeation chromatography, and other methods as is known in the art. The isocyanate compound can be monomeric and/or polymeric, as are known in the art. In addition, the isocyanate compound can have an isocyanate equivalent weight of 80 to 400.

As used herein, polymeric isocyanate compounds contain two or more than two —NCO groups per molecule. For the various embodiments, the polymeric isocyanate compound is selected from an aliphatic diisocyanate, a cycloaliphatic diisocyanate, an aromatic diisocyanate, a polyisocyanate, an isocyanate prepolymer and combinations thereof. For the various embodiments, the polymeric isocyanate compound has a number average molecular weight of 150 g/mol to 500 g/mol. In addition, the polymeric isocyanate compound can have an isocyanate equivalent weight of 80 to 150, preferably of 100 to 145 and more preferably of 110 to 140.

Examples of the polymeric isocyanate compound of the present disclosure can include, but is not limited to, methylene diphenyldiisocyanate (MDI), polymethylene polyphenylisocyanate containing MDI, polymeric MDI (PMDI), 1,6 hexamethylenediisocyanate (HDI), 2,4- and/or 2,6-toluenediisocyanate (TDI), 1,5-naphthalene diisocyanate (NDI), tetramethylene-1,4-diisocyanate, cyclohexane-1,4-diisocyanate, hexahydrotoluene diisocyanate, hydrogenated MDI (H₁₂ MDI), methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4′-diisocyanate, 4,4′,4″-triphenylmethane diisocyanate, polymethylene polyphenylisocyanates, hydrogenated polymethylene polyphenyl polyisocyanates, toluene-2,4,6-triisocyanate and 4,4′-dimethyldiphenylmethane-2,2′,5,5′-tetraisocyanate, methylene bicyclohexylisocyante (HMDI), isophoronediisocyanate (IPDI) and combinations thereof. Suitable isocyanates can also include other aromatic and/or aliphatic polyfunctional isocyanates. Aromatic diisocyanates include those containing phenyl, tolyl, xylyl, naphthyl, or diphenyl moiety, or a combination thereof, such as trimethylol propane-adducts of xylylene diisocyanate, trimethylol propane-adducts of toluene diisocyanate, 4,4′-diphenyldimethane diisocyanate (MDI), xylylene diisocyanate (XDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, and a combination thereof. Suitable aliphatic polymeric isocyanate compounds include trimers of hexamethylene diisocyanate, trimers of isophorone diisocyanate, biurets of hexamethylene diisocyanate, hydrogenated polymeric methylene diphenyl diisocyanate, hydrogenated methylene diphenyl diisocyanate, hydrogenated MDI, tetramethylxylol diisocyanate (TMXDI), 1-methyl-2,4-diisocyanato-cyclohexane, 1,6-diisocyanate-2,2,4-trimethylhexane, 1-isocyanatomethyl-3-isocyanato-1,5,5-trimethylcyclohexane,tetramethoxybutane 1,4-diisocyanate, butane 1,4-diisocyanate, hexane 1,6-diisocyanate, dicyclohexylmethane diisocyanate, cyclohexane 1,4-diisocyanate, and a combination thereof. Examples of other polymeric isocyanate compounds include additional aliphatic, cycloaliphatic, polycyclic or aromatic in nature such as hydrogenated xylene diisocyanate (HXDI), p-phenylene diisocyanate (PPDI), 3,3′-dimethyldiphenyl-4,4′-diisocyanate (DDDI), 2,2,4-trimethylhexamethylene diisocyanate (TMDI), isophorone diisocyanate (IPDI), 4,4′-dicyclohexylmethane diisocyanate (H12MDI) and norbornane diisocyanate (NDI). As well as the isocyanates mentioned above, partially modified polyisocyanates including uretdione, isocyanurate, carbodiimide, uretonimine, allophanate or biuret structure, and combinations thereof, among others, may be utilized.

In certain embodiments, the isocyanate has a viscosity, at 25° C., of 5 to 10,000mPa·s, when measured using a Brookfield DVE viscometer. Other viscosity values may also be possible. For example, the isocyanate compound can have a viscosity value at 25° C. measured using a Brookfield DVE viscometer from a low value of 5, 10, 30, 60 or 150 mPa·s to an upper value of 500, 2500, 5000 or 10,000 mPa·s.

For the embodiments provided herein, the reaction mixture optionally includes a catalyst, a surfactant, a blowing agent or combinations thereof, as discussed herein, where these components can be provided in the isocyanate-reactive composition discussed herein. The reaction mixture can also include other components known in the art for promoting and/or facilitating the reaction mixture, as provided herein, for forming a polyurethane-based foam. It is understood that the catalyst, the surfactant, the blowing agent or combinations thereof can be present in any combination of the isocyanate-reactive composition and/or the isocyanate compound to arrive at their respective wt. % values provided herein for the reaction mixture. This is also the case for the reaction mixture having the other components known in the art for promoting and/or facilitating the use of the components of the reaction mixture.

The present disclosure also provides for a process for preparing a reaction mixture for producing a polyurethane-based foam. The process can include providing an isocyanate compound having an isocyanate moiety, as discussed herein. The process further includes providing an isocyanate reactive compound having an isocyanate reactive moiety and an aromatic moiety comprising 5 wt. % to 80 wt. % of the isocyanate reactive compound based on the total weight of the isocyanate reactive compound. The process also includes providing 0.1 wt. % to 7.0 wt. % of phosphorus from a halogen-free flame-retardant compound, as discussed herein, and 0.05 wt. % to 14.0 wt. % of a transition metal from a transition metal compound, as discussed herein, where the wt. % values of phosphorus and the transition metal are based on a total weight of the isocyanate reactive compound, the halogen-free flame-retardant compound and the transition metal compound. For these given wt. % values, admixing the isocyanate-reactive composition and the isocyanate compound to form the reaction mixture can include providing a molar ratio of the transition metal to phosphorus (mole transition metal:mole phosphorous) of 0.05:1 to 5:1 in the reaction mixture. The process further includes optionally providing a catalyst, a surfactant and a blowing agent. The process then includes admixing the isocyanate compound, the isocyanate reactive compound, the halogen-free flame-retardant compound; the transition metal compound; and the optional catalyst, surfactant and blowing agent to form the reaction mixture. For the various embodiments, the reaction mixture can have a molar ratio of the isocyanate moiety to the isocyanate reactive moiety of 1.2:1 to 7:1.

An additional embodiment of the process further includes admixing the transition metal compound with a carrier in providing the transition metal from the transition metal compound. As used herein, the carrier is a liquid used to mix with the transition metal compounds that are typically solid powders for forming a slurry or solution to facilitate providing the transition metal from the transition metal compound (e.g., mixing into the isocyanate reactive composition). Any of the liquid components used in the reaction mixture for preparing a polyurethane foam, irrespective of whether it is isocyanate reactive or not, may be used to disperse the transition metal compound. Examples of such carrier liquid include, but not limited to, a polyol, a catalyst, a surfactant, a flame-retardant additive, a liquid blowing agent, a rheological modifier, a liquid dye, etc. Skilled artisans also know that the transition metal compound may even be dispersed directly into an isocyanate compound for making polyurethane foams. For the various embodiments, it is also possible to admix the 0.1 wt. % to 7.0 wt. % of phosphorus from the halogen-free flame-retardant compound (the wt. % of phosphorus based on a total weight of the isocyanate reactive compound, the halogen-free flame-retardant compound and the transition metal compound) with the isocyanate compound having the isocyanate moiety, as discussed herein, during the process for preparing a reaction mixture for producing a polyurethane-based foam.

As previous discussed, the catalyst, the surfactant, the blowing agent or combinations thereof for the reaction mixture can be optionally provided in the isocyanate-reactive composition, as discussed herein. Admixing the other components, as provided herein, with the isocyanate-reactive composition and the isocyanate compound in forming the reaction mixture is also possible. It is understood that the catalyst, the surfactant, the blowing agent or combinations thereof can be present in any combination of the isocyanate-reactive composition and/or the isocyanate compound to arrive at their respective wt. % values provided herein for the reaction mixture. This is also the case for the reaction mixture having the other components known in the art for promoting and/or facilitating the use of the isocyanate-reactive composition with the isocyanate compound in the reaction mixture.

Processes for preparing the reaction mixture for producing a polyurethane-based foam can be achieved through any known process techniques in the art. In general, the polyurethane-based foam of the present disclosure may be produced by discontinuous or continuous processes, including the process referred to generally as the discontinuous panel process (DCP) and continuous lamination, with the foaming reaction and subsequent curing being carried out in molds or on conveyors. The process as provided herein can be performed at a temperature from 15° C. to 80° C. Mixing pressures for the process can include values of 80 kPa to 25,000 kPa. The admixing can be performed using a mixing device as are known in the art. The density of the resulting foam may be 10 kg/m³ or more, preferably 15 kg/m³ or more, more preferably 25 kg/m³ or more, most preferably 35 kg/m³ or more, and at the same time typically 200 kg/m³ or less, preferably 100 kg/m³ or less, more preferably 70 kg/m³ or less, and still most preferably 50 kg/m³ or less. The polyurethane-based foam of the present disclosure offers low smoke generation and high thermal stability determined according to ASTM E662 “Test Method for Specific Optical Density of Smoke Generated by Solid Materials”. Lower values of Maximum Specific Optical Density (Max Ds) mean lower smoke generation. Lower values of mass loss % mean greater thermal stability. The Max Ds may be 400 or less, preferably 200 or less, more preferably 100 or less, and still most preferably 50 or less. The mass loss % may be 50% or less, preferably 45% or less, more preferably 40% or less, and still most preferably 35% or less.

Polyurethane-based foams of the present disclosure may have low thermal conductivity in applications such as for building insulation. Thermal conductivity of rigid foams is expressed by the K-factor. The K-factor is a measurement of the insulating properties. The K factor of the prepared foams may be 30.0 mW/m·K or less, preferably 27.0 mW/m·K or less, more preferably 24.0 mW/m·K or less, and still most preferably 22.0 mW/m·K or less. Thermal conductivity (K-Factor) was measured using ASTM C-518-17 at mean temperature of 75° F.

The applications for the polyurethane-based foams produced by the present disclosure are those known in the industry. For example, the polyurethane-based foams can be used for insulation used in building wall and roofing, in garage doors, in shipping trucks and railcars, and in cold storage facilities. The polyurethane-based foams disclosed herein may have a combination of properties that are desirable for these applications. For instance, the polyurethane-based foams disclosed herein may advantageously provide desirable low thermal conductivity, smoke density, thermal stability, and improved combustion characteristics with reduced HCN and CO emission.

Some embodiments of the disclosure will now be described in detail in the following Examples.

### EXAMPLES

In the Examples, various terms and designations for materials were used including, for example, the following:

Materials

Materials employed in the examples and/or comparative examples include the following. Polyol A is a polyester polyol (an aromatic polyester polyol from terephthalic acid, polyethylene glycol, and diethylene glycol), having a hydroxyl number of 220 mg KOH/g, a functionality of 2, and a total content of aromatic moieties of 14.8 wt. %, from Dow Inc.

Polyol B is a polyester polyol (an aromatic polyester polyol from terephthalic acid, polyethylene glycol, glycerol, and diethylene glycol), having a hydroxyl number of 315 mg KOH/g, a functionality of 2.4, and a total content of aromatic moieties of 17.4 wt. %, from Dow Inc.

Triethyl phosphate (TEP) is a fire retardant from LANXESS.

Fyrolflex™ Resorcinol bis(diphenyl phosphate) (RDP) is a fire retardant from ICL Industrial Products.

Diethyl (hydroxymethyl)phosphonate (DEHMP) is a fire retardant from Tokyo Chemical Industry Co., Ltd.

POLYCAT™ 5 is a catalyst from Evonik Industries AG.

POLYCAT™ 46 is a catalyst from Evonik Industries AG.

Surfactant is a silicone rigid foam surfactant from Evonik Industries AG.

Water is deionized water having a specific resistance of 10 MΩ×cm (million ohms) at 25° C.

Cyclopentane (c-Pentane) is a blowing agent from Sigma-Aldrich.

PAPI™ 580N is a polymethylene polyphenylisocyanate containing methylene diphenyl diisocyanate (MDI) with 30.8% isocyanate from Dow Inc.

Ethylenediaminetetraacetic acid copper disodium salt (CuEDTA) from Fluka.

Copper (II) 2-ethylhexanoate (CuEH) from Sigma-Aldrich.

Copper (I) oxide (Cu₂O), powder, size≤7 μm, 97% from Sigma-Aldrich.

Copper (II) oxide (CuO), powder, size≤10 μm, 98% from Sigma-Aldrich.

Copper (II) oxide (CuO), powder, size 10 nm, 98% from US Research Nanomaterials, Inc.

Copper (II) oxide (CuO), powder, size 40 nm, 98% from US Research Nanomaterials, Inc.

Dicyclopentadienyl iron (Ferrocene) from Fluka.

### Preparation of Polyurethane-Based Foams for Examples (Ex) and Comparative Examples (C Ex)

Use the following components in the reaction mixtures to form polyurethane-based foams for Examples (Ex.) 1-17 and Comparative Examples (C Ex.) A-F. The amounts of each component are given in parts by weight (PBW) based on the total weight of the reaction mixture used to form the polyurethane-based foam. The amount of the “Transition Metal Compound” are seen in the Tables 1, while the composition of the “Transition Metal Compound” for each Example and Comparative Example is seen in Tables 2 through 5.

TABLE 1
Reaction Mixture for Polyisocyanurate Ex and
C Ex of Polyurethane-Based Foams (Isocyanate Index 387)

| Component | PBW |
|---|---|
| Isocyanate-Reactive Composition | |
| Polyester Polyol A | 16.33 |
| Polyester Polyol B | 5.44 |
| Phosphorus from phosphorus compound | 0.3 to 1.5 |
| POLYCAT ™ 5 catalyst | 0.26 |
| POLYCAT ™ 46 catalyst | 0.49 |
| Surfactant | 0.77 |
| Water | 0.20 |
| Cyclopentane | 5.38 |
| Transition Metal from | 0 to 3.0 |
| Transition Metal Compound | |
| Isocyanate | |
| PAPI ™ 580N | 67.28 |

Prepare the polyurethane-based foams as follows. For each Ex and C Ex mix the components of the isocyanate-reactive composition, except cyclopentane and the transition metal compound provided in Tables 1, in a plastic beaker at 2000 rpm with a rotary mixer for 1 minute (min). Mix the transition metal compound for each Ex and C Ex directly with the isocyanate-reactive composition at 2000 rpm for another 1 min, except for the use of the following transition metal compounds. For CuEH, first dissolve the CuEH in TEP and mix with the remaining components of the isocyanate-reactive composition. Then, mix cyclopentane for each Ex and C Ex directly with the isocyanate-reactive composition. Next, mix the isocyanate-reactive composition and isocyanate in the beaker again at 3000 rpm for 4 seconds (s). After mixing, immediately pour the content of the beaker into a mold (300-millimeter (mm)×200 mm×50 mm) preheated to 60° C. Remove the polyurethane-based foam from the mold after curing at 60 ° C. for 20 minutes. The core density of the molded polyurethane-based foam was approximately 40 kg/m³.

### Analysis of Composition of Smoke Gases

Method 1—Pyrolysis/GC

Conduct pyrolysis testing using a Frontier Labs 2020D pyrolyzer mounted on an Agilent 6890 GC with a FID detector. Weigh approximate 200-250 μg of sample into a Frontier labs silica lined stainless steel cup. Perform the pyrolysis by a single shot mode by dropping the sample cup into the oven for analysis under air conditions at 600° C. for 2 min followed under helium conditions for another 2 min. Trap the volatile products emitted from the sample at the head of the separation column using a micro-cryo trapping device (MCT). Achieve separation using a 10 m×0.32 mm ID×5 μm PoraBond Q column from Agilent with a HP-1 (10 m×0.53mm×2.65 um) as a guard column. Use the back-inlet pressure for the backflush purpose (a 0.5 m×0.53 mm guard column using back-inlet as its head pressure tee into PoraBond Q and HP-1 columns). The HCN was detected on back FID detector. Use a normalized peak area of HCN by sample weight for HCN concentration comparison. The relative HCN content of transition metal containing sample is defined as the ratio of its normalized HCN peak area divided by the normalized HCN peak area for Comparative Control Example with no transition metal.

GC Conditions: Front injection Port: 300° C.; Split injector at 1:1; Ramped pressure: 4.9 psi hold for 1.5 min, then to 3.1 psi at 50 psi/min; Back injection port: 4 psi; GC Oven: 40° C. hold for 3 min, to 240° Cat 30° C./min; FID: 250° C., H2 flow:40 mL/min, air flow: 450 mL/min, make-up gas (N2): 30 mL/min, 50 Hz.

Method 2—NBS/FTIR

Conduct the NBS Smoke Chamber Testing Protocol according to ISO 5659:1994, Plastics-Smoke Generation—Part 2: Determination of Optical Density by a Single Chamber Test. Expose the samples to an irradiance of 50 kW/m² in flaming exposure mode for a test period of 20 min. Use a Fourier Transform Infrared (FTIR) spectrometer to analyze products of combustion. Begin gas sampling for toxicity measurements at the start of exposure and continue until the end of the test period. Report the maximum detected concentrations in parts per million and the mass loss % of the specimen as (initial mass−final mass)/nominal mass*100%. The nominal mass of the specimen is the total mass of a foam specimen with a dimension of 3″×3″×1″. The relative HCN content or CO content of transition metal containing sample is defined as the ratio of maximum HCN or maximum CO concentration normalized by the maximum HCN or maximum CO concentration for Comparative Control Example with no transition metal.

### NBS Smoke Density and Mass Loss % Measurement

Conduct the NB S Smoke Density measurement according to ASTM E-662 Standard Test Method for Specific Optical Density of Smoke Generated by Solid Materials. Expose the samples to an irradiance of 25 kW/m² in flaming exposure mode for a test period of 10 min. Report the average maximum specific optical density (D_{s, max}) and the mass loss % of the specimen as (initial mass−final mass)/nominal mass*100%. The nominal mass of the specimen is the total mass of a foam specimen with a dimension of 3″×3″×1″.

### Relative Isocyanurate Content Measurement

Conduct Attenuated Total Reflectance Fourier Transform Infrared Spectroscopy (ATR-FTIR) test on a Nicolet iS50 FT-IR instrument with SMART iTX single bounce diamond ATR. Acquire sixteen scans in the 4000-600cm⁻¹ spectral range with a resolution of 4 cm⁻¹. Cut a rectangular cross section (10 mm×60 mm) from the center of a molded polyurethane-based foam sample. Conduct three tests on the cross section averaging the 3 measurements for the characteristic peak. The relative isocyanurate content is defined as the ratio of isocyanurate group characteristic peak height (˜1409 cm⁻¹) and phenyl group characteristic peak height (˜1595 cm⁻¹) normalized by this peak height ratio for Comparative Control Example with no transition metal.

### Results

Table 2 shows significant reduction of HCN generation from pyrolysis/GC (relative HCN concentration <0.70) while maintaining excellent smoke density and thermal stability of the polyurethane-based foams (Max Ds<=45, mass loss value <=35%, and relative isocyanurate content >=0.60).

TABLE 2

| | C EX A | C EX B | C EX C | Ex 1 | Ex 2 | Ex 3 | Ex 4 | Ex 5 | EX 6 | Ex 7 | Ex 8 | EX 9 |
|---|---|---|---|---|---|---|---|---|---|---|---|---|
| Transition Metal additive | None | Cu₂O | Cu₂O | Cu₂O | Cu₂O | Cu₂O | Cu₂O | Cu₂O | Cu₂O | Cu₂O | Cu₂O | Cu₂O |
| Transition Metal ion wt. % | 0 | 0.25 | 0.025 | 0.1 | 0.25 | 0.5 | 1.0 | 2.0 | 3.0 | 0.25 | 0.25 | 3.0 |
| Source of P | TEP | None | TEP | TEP | TEP | TEP | TEP | TEP | TEP | TEP | TEP | TEP |
| P wt. % | 0.65 | 0 | 0.65 | 0.65 | 0.65 | 0.65 | 0.65 | 0.65 | 0.65 | 0.3 | 1.5 | 0.3 |
| Transition Metal/P Molar | 0 | | 0.02 | 0.07 | 0.19 | 0.38 | 0.75 | 1.50 | 2.25 | 0.41 | 0.08 | 4.88 |
| ratio | | | | | | | | | | | | |
| Relative HCN | 1.00 | 0.05 | 1.27 | 0.18 | 0.18 | 0.10 | 0.09 | 0.08 | 0.10 | 0.10 | 0.32 | 0.06 |
| concentration | | | | | | | | | | | | |
| Relative isocyanurate | 1.00 | 1.05 | 1.05 | 0.96 | 0.86 | 0.85 | 0.82 | 0.91 | 1.09 | 0.85 | 1.27 | 1.03 |
| content | | | | | | | | | | | | |
| Max Ds (ASTM E-662) | 21 | 60 | 28 | 44 | 30 | 25 | 23 | 28 | 34 | 36 | 44 | 36 |
| Mass loss %, (ASTM | 20.3% | 33.9% | 22.0% | 25.4% | 23.7% | 22.0% | 23.7% | 25.4% | 28.8% | 22.0% | 27.1% | 32.2% |
| E-662) | | | | | | | | | | | | |

As seen in Tables 3 and Table 4, significant reduction of HCN generation from pyrolysis/GC, excellent smoke density, and isocyanurate content are achieved with different phosphorus compounds.

TABLE 3

| | C EX D | Ex 10 |
|---|---|---|
| Transition Metal additive | NONE | Cu₂O |
| Transition Metal ion wt. % | 0 | 0.5 |
| Source of P | DEHMP | DEHMP |
| P wt. % | 0.65 | 0.65 |
| Transition Metal/P Molar ratio | 0 | 0.38 |
| Relative HCN concentration | 1.00 | 0.13 |
| Relative isocyanurate content | 1.00 | 1.00 |
| Max D_{S} (ASTM E-662) | 30 | 34 |
| Mass loss % (ASTM E-662) | 27.1% | 27.1% |

TABLE 4

| | C EX E | Ex 11 |
|---|---|---|
| Transition Metal additive | NONE | Cu₂O |
| Transition Metal ion wt. % | 0 | 0.5 |
| Source of P | RDP | RDP |
| P wt. % | 0.65 | 0.65 |
| Transition Metal/P Molar ratio | 0 | 0.38 |
| Relative HCN concentration | 1.00 | 0.24 |
| Relative isocy anurate content | 1.00 | 1.05 |
| Max D_{S} (ASTM E-662) | 29 | 55 |
| Mass loss % (ASTM E-662) | 18.6% | 23.7% |

As seen in Tables 5, significant reduction of HCN generation from pyrolysis/GC can be achieved with addition of different types of transition metal compounds.

TABLE 5

| | C EX A | Ex 12 | Ex 14 | Ex 14 | Ex 15 |
|---|---|---|---|---|---|
| Transition Metal Additive | | CuEDTA | CuEDTA | Cu(OAc)₂ | Ferrocene |
| Transition Metal ion wt. % | 0 | 0.25 | 0.5 | 0.5 | 0.5 |
| P wt. % | 0.65 | 0.65 | 0.65 | 0.65 | 0.65 |
| Transition Metal/P molar ratio | 0 | 0.19 | 0.38 | 0.38 | 0.43 |
| Relative HCN concentration | 1.00 | 0.28 | 0.02 | 0.20 | 0.64 |
| Relative isocyanurate content | 1.00 | 0.76 | 0.73 | 0.73 | 0.70 |
| Max D_{S} (ASTM E-662) | 21 | 28 | 43 | 32 | 16 |
| Mass loss %, (ASTM E-662) | 20.3% | 20.3% | 27.1% | 27.1% | 33.9% |

As seen in Tables 6, a significant reduction of HCN generation from pyrolysis/GC can be achieved from adding transition metal additives of different sizes.

TABLE 6

| | C EX A | Ex 16 | Ex 17 | Ex 18 |
|---|---|---|---|---|
| Transition Metal additive | NONE | CuO | CuO | CuO |
| Additive average particle size | NONE | 10 μm | 40 nm | 10 nm |
| Transition Metal ion wt. % | 0 | 0.5 | 0.5 | 0.5 |
| Source of P | TEP | TEP | TEP | TEP |
| P wt. % | 0.65 | 0.65 | 0.65 | 0.65 |
| Transit on Metal/P Molar ratio | 0 | 0.38 | 0.38 | 0.38 |
| Relative HCN concentration | 1.00 | 0.24 | 0.12 | 0.28 |
| Relative isocyanurate content | 1.00 | 0.65 | 0.76 | 0.79 |

As seen in the NBS/FTIR testing under high heat flux exposure (50 kw/m²) condition (Table 7), there was a significant reduction of HCN and CO observed for polyurethane-based foams with Cu₂O at all concentrations. Surprisingly, greater efficient HCN and CO reduction together with higher char yield was achieved at copper concentration of 0.25 wt. %. The copper compound CuEH which is soluble in isocyanate reactive composition is used, the HCN emission were higher than the control (C EX A).

TABLE 7

| | C EX A | C EX F | Ex 2 | Ex 3 | Ex 4 |
|---|---|---|---|---|---|
| Transition Metal additive | None | CuEH | Cu₂O | Cu₂O | Cu₂O |
| Transition Metal ion wt. % | 0 | 0.25 | 0.25 | 0.5 | 1.0 |
| Type of P | TEP | TEP | TEP | TEP | TEP |
| P wt. % | 0.65 | 0.65 | 0.65 | 0.65 | 0.65 |
| Transition Metal/P Molar ratio | 0 | 0.19 | 0.19 | 0.38 | 0.75 |
| Relative Max HCN concentration | 1.00 | 1.25 | 0.27 | 0.84 | 0.78 |
| Relative Max CO concentration | 1.00 | 0.92 | 0.17 | 0.71 | 0.72 |
| Relative isocyanurate content | 1.00 | 0.67 | 0.86 | 0.85 | 0.82 |
| Max D_{S} | 46 | 193 | 51 | 49 | 40 |
| Mass loss % | 49.1% | 67.8% | 42.4% | 47.5% | 52.5% |
| K factor (mW/m · K) | 20.8 | 20.9 | 20.7 | 21.6 | 20.9 |

1. An isocyanate-reactive composition for forming a polyurethane-based foam, comprising:
an isocyanate reactive compound having an isocyanate reactive moiety and an aromatic moiety, wherein the aromatic moiety is 5 weight percent (wt. %) to 80 wt. % of the isocyanate reactive compound based on the total weight of the isocyanate reactive compound; and
a combustion modifier composition that includes:
0.1 wt. % to 7.0 wt. % of phosphorus from a halogen-free flame-retardant compound; and
0.05 wt. % to 14.0 wt. % of a transition metal from a transition metal compound, wherein the wt. % of the transition metal and wt. % of the phosphorous are each based on the total weight of the isocyanate reactive compound, the halogen-free flame-retardant compound and the transition metal compound.

2. The isocyanate-reactive composition of claim 1, wherein the combustion modifier composition has a molar ratio of the transition metal to phosphorus of 0.05:1 to 5:1.

3. The isocyanate-reactive composition of claim 1, wherein the halogen-free flame-retardant compound is selected from the group consisting of a phosphate, a phosphonate, a phosphinate and combinations thereof.

4. The isocyanate-reactive composition of claim 1, wherein the transition metal compound is selected from the group consisting of an oxide, a carboxylate, a salt, a coordination compound and combinations thereof and the transition metal is selected from the group consisting of copper, iron, manganese, cobalt, nickel, zinc and combinations thereof

5. The isocyanate-reactive composition of claim 1, wherein the transition metal compound is selected from the group consisting of copper (I) oxide, copper (II) oxide, ethylenediaminetetraacetic acid (EDTA) copper disodium salt and combinations thereof

6. The isocyanate-reactive composition of claim 1, wherein the transition metal compound has a median particle diameter of 10 nm to 10 μm.

7. A reaction mixture for forming a polyurethane-based foam, comprising:
an isocyanate compound having an isocyanate moiety;
an isocyanate reactive compound having an isocyanate reactive moiety and an aromatic moiety comprising 5 weight percent (wt. %) to 80 wt. % of the isocyanate reactive compound based on the total weight of the isocyanate reactive compound, 0.1 wt. % to 7.0 wt. % of phosphorus from a halogen-free flame-retardant compound and 0.05 wt. % to 14.0 wt. % of a transition metal from a transition metal compound, wherein the wt. % values of phosphorus and the transition metal are based on a total weight of the isocyanate reactive compound, the halogen-free flame-retardant compound and the transition metal compound; and
optionally a catalyst, a surfactant, a blowing agent or combinations thereof.

8. The reaction mixture of claim 7, wherein the reaction mixture has a molar ratio of the isocyanate moiety to the isocyanate reactive moiety of 1.2:1 to 7:1.

9. A polyurethane-based foam formed with the reaction mixture of claim 7.

10. A process for preparing a reaction mixture for producing a polyurethane-based foam, the process comprising:
providing an isocyanate compound having an isocyanate moiety;
providing the isocyanate-reactive composition of claim 1;
optionally providing a catalyst, a surfactant, a blowing agent or combinations thereof; and
admixing the isocyanate compound, the isocyanate-reactive composition and the optional catalyst, surfactant, blowing agent or combinations thereof to form the reaction mixture, wherein the reaction mixture has a molar ratio of the isocyanate moiety to the isocyanate reactive moiety of 1.2:1 to 7:1.
